(19) United States
(12) Patent Application Publication
(10) Pub. No.: US 2008/0204336 A1
(43) Pub. Date: Aug. 28, 2008

(54) Antenna Device for Seismic Surveys

(75) Inventor: Bjornar Svenning, Trondheim (NO)

Correspondence Address: AKERMAN SENTERFITT, P.O. BOX 3188, WEST PALM BEACH, FL, 33402-3188, US

(73) Assignee: Innovative Development & Marketing AS, Trondheim (NO)

(21) Appl. No.: 11/997,333

(22) PCT Filed: Jul. 28, 2006
(86) PCT No.: PCT/NO2006/000287

§ 371 Date: Mar. 12, 2008

(30) Foreign Application Priority Data
Aug. 3, 2005 (NO) 20053727

(51) Int. Cl. H01Q 1/04

(52) U.S. Cl. 343/719

(57) ABSTRACT

An antenna device (10′, 10″, 10′″, 10″″) for seismic surveys, where the antenna (10′, 10″, 10′″, 10″″), when in the active position, is located by the seabed (2), and where the antenna (10′, 10″, 10′″, 10″″) is coupled to one end portion of at least one feed-out hollow element (12a, 12b), the opposite end portion of the feed-out hollow element (12a, 12b) being coupled to a fluid supply (14a, 14b, 16).

This invention regards an antenna for seismic surveys. More particularly, it regards an antenna which in the active position is located by the seabed, where the antenna is coupled to one end portion of at least one feed-out hollow element, preferably roll-out hollow element, while the other end portion of the hollow element is coupled to a fluid supply. The antenna is particularly suited for use with receivers of the type to be lowered to the seabed.

When carrying out seismic surveys, and in particular in the case of so-called seabed logging (SBL), which uses low frequency electromagnetic waves, receivers are required to be placed near the seabed. It has been found that the SBL technique is useful in determining e.g. whether a fluid being relatively deep under the seabed consists of water or hydrocarbons.

Prior art receivers for this purpose typically comprise a frame containing the required electronic equipment, a releasable anchor and also buoyancy elements. Relatively long antenna stays project in four directions from the frame, the free end portion of each stay being provided with an antenna. It is important for the antennas to be spaced apart.

The receivers are lowered into the sea from a vessel and are allowed to sink freely to the seabed, where the antennas settle by the seabed. The positions of the receivers are determined by techniques that are known per se, whereupon signals received by the antennas are transferred to appropriate data processing equipment.

The term “by the seabed” also includes the antenna being on the seabed.

Handling the relatively long antenna stays during mounting, and not least during deployment, has proven to be complicated, and to some extent also dangerous for those present on deck of the vessel during these operations. Previously known antenna stays also require considerable storage space on deck, and for practical reasons they can hardly be any longer than approximately 5 metres.

The object of the invention is to remedy or reduce at least one of the drawbacks of prior art.

The object is achieved in accordance with the invention, by the features set forth in the description below and in the following claims.

According to the invention, an antenna for seismic surveys, which in the active position is located by the seabed, is coupled to the one end portion of a feed-out, preferably roll-out hollow element, while the opposite end portion of the hollow element is coupled to a fluid supply. The length of the hollow element can be e.g. 30 metres.

Advantageously the antenna is coupled to two parallel hollow elements, allowing the direction of feed-out to be controlled by controlling the fluid flow to each of the hollow elements.

The fluid supply, which is preferably located within the frame, typically comprises a pump arranged to pump seawater into the hollow element via control valves. The pump is normally powered by an accumulator.

It is desirable that each receiver should comprise two pairs of antennas at right angles to each other. Each antenna may comprise electronic and magnetic sensors of an appropriate type.

The control valve is controlled by control circuits that receive signals indicating the position of the antenna in question, compare this position with a desired position along the feed-out path, and then correct the interrelated fluid flow to the two hollow elements to bring the antenna into the correct relative position.

By doing so, one avoids feeding the antenna out to an undesirable position because of e.g. uneven ground on the seabed.

Advantageously the antenna emits a signal for each revolution of the feed-out process, so as to make it possible to determine how many revolutions it has gone through.

Upon completion of the seabed survey, the anchor is disengaged from the frame by remote control, whereby the frame, together with the hollow elements, ascends through the water to be retrieved for subsequent use.

The following describes a non-limiting example of a preferred embodiment illustrated in the accompanying drawings, in which:

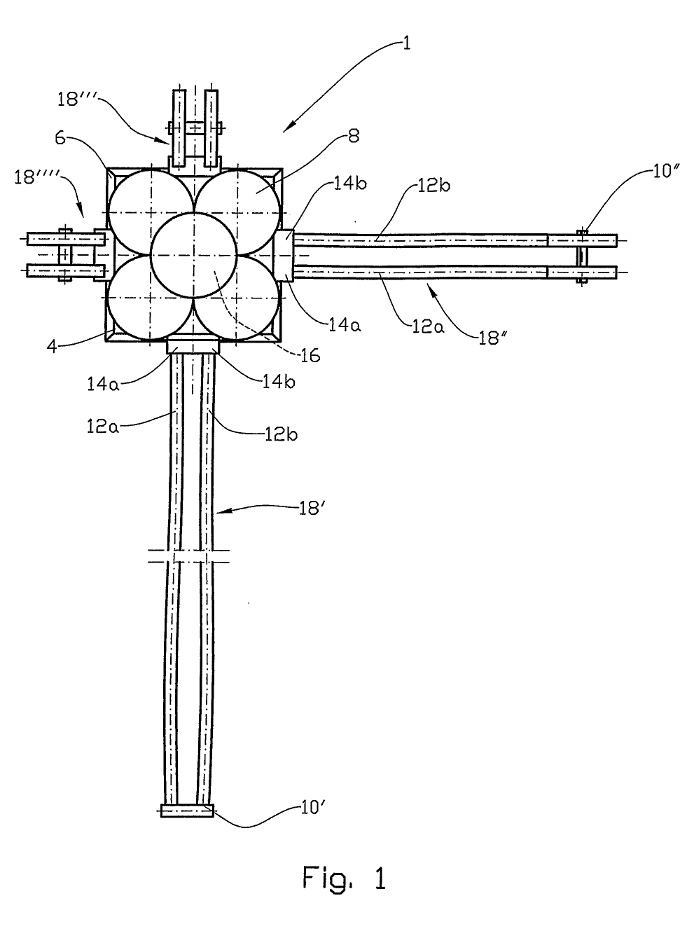

FIG. 1 is a schematic plan view of a receiver disposed on the seabed, where the antennas are being fed out from the frame of the receiver; and

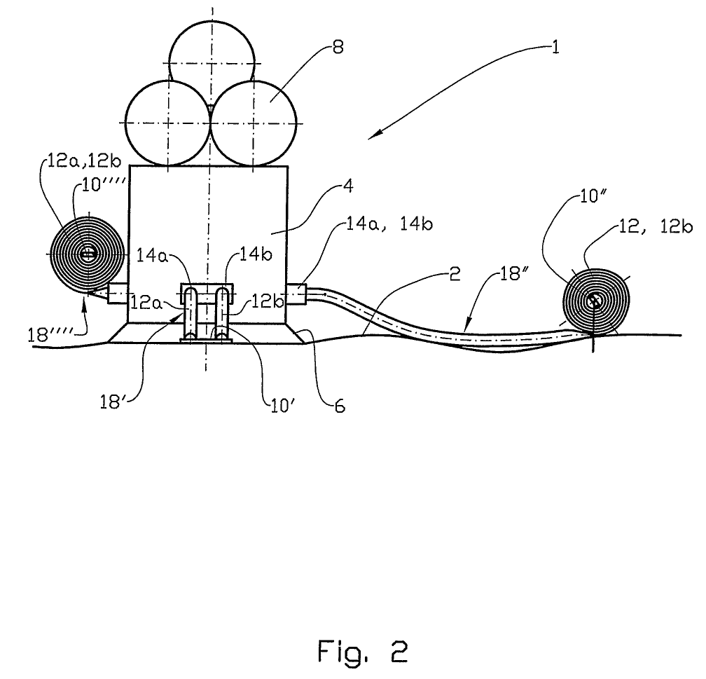

FIG. 2 is a schematic side view of the receiver of FIG. 1.

In the drawings, reference number 1 denotes a receiver disposed on the seabed 2, and which comprises a cubic frame 4, a releasable anchor 6 and buoyancy element 8.

The receiver 1 comprises four antennas 10′, 10″, 10′″ and 10″″. Each antenna 10′-10″″ is coupled to the free end portions of two parallel roll-out hollow elements 12a, 12b. The roll-out hollow elements 12a, 12b are constituted by flexible hoses.

At the opposite end portion, the roll-out hollow elements 12a, 12b are coupled to their respective control valves 14a, 14b which are supplied with water from a pump 16. Together, the pump 16 and the control valves 14a, 14b form the fluid supply.

Each antenna 10′, 10″, 10′″ and 10″″, together with the respective roll-out hollow elements 12a, 12b and control valves 14a, 14b, form an antenna feed-out device 18′, 18″, 18′″ and 18″″. The antenna feed-out devices 18′, 18″, 18′″ and 18″″ are sequentially coupled to the fluid supply 16.

In FIG. 1, the roll-out hollow elements 12a, 12b of the first antenna 10′ has been rolled out, whereby the antenna 10′ has been placed in its operative position. The roll-out hollow elements 12a, 12b of the second antenna 10″ are in the process of being rolled out, with the pump 16 pumping seawater into the roll-out hollow elements 12a, 12b via the control valves 14a, 14b.

The direction of roll-out of the second antenna 10″ is controlled as described in the general section of the present application, by controlling the relative flow of water through the control valves 14a and 14b.

The third antenna 10′″ and the fourth antenna 10″″ have not yet been rolled out.

Together, the first antenna 10′ and the third antenna 10′″ form a first pair of antennas, while the second antenna 10″ and the fourth antenna 10″″ form a second pair of antennas arranged generally at right angles to the first pair of antennas.

1. An antenna device (10′, 10″, 10′″, 10″″) for seismic surveys, where the antenna (10′, 10″, 10′″, 10″″), when in the active position, is located by the seabed (2), characterized in that the antenna (10′, 10″, 10′″, 10″″) is coupled to one end portion of at least one feed-out hollow element (12a, 12b), the opposite end portion of the feed-out hollow element (12a, 12b) being coupled to a fluid supply (14a, 14b, 16).

2. A device in accordance with claim 1, characterized in that the hollow element (12a, 12b) can be rolled out.

3. A device in accordance with claim 1, characterized in that the antenna (10′, 10″, 10′″, 10″″) is coupled to a first feed-out hollow element (12a) and a second feed-out hollow element (12b) which is essentially parallel to the first feed-out hollow element (12a), the hollow elements (12a, 12b) being coupled to separate respective control valves (14a, 14b).

4. A device in accordance with claim 3, characterized in that the flow through the control valves (14a, 14b) can be controlled based on the relative position of the corresponding antenna (10′, 10″, 10′″, 10″″).

5. A device in accordance with claim 1, characterized in that the feed-out devices (18′, 18″, 18′″, 18″″) of the receiver (1) sequentially receive fluid from a pump (16) during feed-out of the antennas (10′, 10″, 10′″, 10″″).
